(19) United States
(12) Patent Application Publication
(10) Pub. No.: US 2005/0272313 A1
(43) Pub. Date: Dec. 8, 2005

(54) Electrical connector

(76) Inventors: Shozo Ichikawa, Kanagawa (JP); Tomonari Kaneko, Kanagawa (JP)

Correspondence Address: Robert J Zeitler;Molex Incorporated, 2222 Wellington Court, Lisle, IL, 60532, US

(21) Appl. No.: 10/523,432

(22) PCT Filed: Jul. 31, 2003
(86) PCT No.: PCT/US03/23934

§ 371 Date: Jan. 28, 2005

(30) Foreign Application Priority Data
Jul. 31, 2002 (JP) 222458/2002
Jul. 31, 2002 (JP) 222457/2002

(51) Int. Cl. H01R 9/03

(52) U.S. Cl. 439/610

(57) ABSTRACT

An improved electrical connector has a construction enhancing durability for cable routing. The electrical connector includes a shield case for covering an insulative housing mounting a plurality of terminals, each of the terminals having a contact piece and a terminal piece, at least at a portion of the terminal piece extending from the insulative housing in a direction away from the contact piece, the terminal piece being capable of being connected to an electric wire of a cable an over-molding portion for securing the shield case along with the cable to shape the electrical connector, the shield casing having a tube-like portion engaging with a portion of the insulative housing and a box-like portion internally receiving at least a portion of the terminal piece and the electrical wire of the cable, and the tube-like portion and the box-like portion being connected via a continuous piece, the tube-like portion including a bending piece externally projecting from an edge of the tube like portion, the continuous piece and the bending piece being embedded in the over-molding portion. The insulative housing may also include a housing cap formed with terminal insertion holes, and a rear end opening portion of the terminal receiving spaces formed in the housing body is sealed by the housing cap. Also, terminal pieces of the terminals mounted in the terminal receiving spaces are rearwardly extended through the terminal insertion holes of the housing cap.

### FIELD OF THE INVENTION

The present invention relates generally to an electrical connector. More particularly, the invention relates to the electrical connector employed as an I/O connector for connecting a personal computer and other electronic equipment to peripheral devices thereof.

### DESCRIPTION OF THE RELATED ART

Conventionally, as this type electrical connector, there has been known one secured and molded by an over-mold portion, after covering an insulative housing mounting a plurality of terminals by a shield case, and connecting each terminal to each electric wire of a cable. For example, there has been known a L-shape electrical connector disclosed in Japanese Unexamined Patent Publication (Kokai) No. Heisei 1-29438. With this L-shape electrical connector, the direction of extension of the cable is intersected with the direction of extension of a mating end of the insulative housing at approximately right angle. Also, there has been known a straight-shape electrical connector disclosed in Japanese Unexamined Patent Publication (Kokai) No. Heisei 10-270113. With this L-shape electrical connector, the direction of extension of the cable and the direction of extension of the mating end of the insulative housing are coplanar.

The cable is secured by the over-mold portion to prevent an external force from exerting on a connecting portion between the wires of the cable and the terminals due to cable routing to protect the connecting portion.

As set forth above, in order to protect the connecting portion between the wires of the cable and the terminals from the external force to be exerted during cable routing, it is typically employed a technology for embedding respective members forming the electrical connector in the over-molded portion. However, there is a strong demand for the electrical connector which can achieve not only protection of the connecting portion between the wires of the cable and the terminals but also enhancement of integrity of the over-molded portion and the cable and of integrity of the over-molded portion and the shield case.

### SUMMARY OF THE INVENTION

The present invention has been worked out in order to solve the problem set forth above. It is an object of the present invention to provide an improved electrical connector having a construction enhancing durability for cable routing.

Another object of this invention is to provide new and highly reliable electrical connector including insulative housing adapted for preventing the over-molded resin from penetrating around the contact portion of each terminal.

With the electrical connector according to the present invention, the shield case is formed by integrating the tube-like portion and the box-like portion via the continuous piece, the bending piece is externally projected from the end edge of the tube-like portion, the continuous piece and the bending piece are embedded in the over-molding portion, and the bonding piece and the over-molding portion are interengaged for enhancing integrity of the tube-like portion of the shield body and the over-molding portion. Thus even when a load is exerted on the tube-like portion in some wire routing, the shield case and the over-molding portion are never separated. On the other hand, the shield case and the over-molding portion are integrated to cooperatively resist against load upon wire routing to prevent bending of the continuous piece.

In another embodiment of the present invention, by extending the strip-like piece from, the box-like portion of the shield case to provide the cable clamp at the end portion of the depending piece to commonly clamp the cable and the cable holder by the cable clamp. Thus, the cable can be firmly held by the shield case which is integral with the over-molding portion so that load may not be exerted on the connecting portion of the terminal and wire.

In yet another embodiment of the present invention, the rear end opening portion of the terminal receiving spaces formed in the housing body is sealed by the housing cap, so that it is possible to prevent the resin from penetrating around the contact portion of each terminal through the terminal receiving spaces of the insulative housing upon molding the resin for forming the over-mold portion.

### BRIEF DESCRIPTION OF THE DRAWINGS

The present invention will be understood more fully from the detailed description given herebelow and from the accompanying drawings of the preferred embodiment of the present invention, which, however, should not be taken to be limitative to the invention, but are for explanation and understanding only.

In the drawings:

FIG. 1 is an enlarged section of an embodiment of an electrical connector according to the present invention, taken generally along line A-A of FIG. 2;

FIG. 2 is a plan view of the embodiment of the electrical connector;

FIG. 3 is a bottom view of the embodiment of the electrical connector,

FIG. 4 is a left side elevational view of the embodiment of the electrical connector,

FIG. 5 is a right side elevational view of the embodiment of the electrical connector;

FIG. 6 is a top plan view of an insulative housing constructing the embodiment of the electrical connector,

FIG. 7 is a plan view of the embodiment of the insulative housing;

FIG. 8 is a left side elevational view of the embodiment of the insulative housing;

FIG. 9 is a right side elevational view of the embodiment of the insulative housing;

FIG. 10 is a section taken generally along line B-B of FIG. 6;

FIG. 11 is a section taken generally along line C-C of FIG. 6;

FIG. 12 is a plan view of a shield body constructing the embodiment of the electrical connector;

FIG. 13 is a bottom view of the embodiment of the shield body;

FIG. 14 is a left side elevational view of the embodiment of the shield body;

FIG. 15 is a right side elevational view of the embodiment of the shield body;

FIG. 16 is a section taken generally along line D-D of FIG. 12;

FIG. 17 is a plan view of a shield cap constructing the embodiment of the electrical connector;

FIG. 18 is a top plan view of the embodiment of the shield cap;

FIG. 19 is a left side elevational view of the embodiment of the shield cap;

FIG. 20 is a right side elevational view of the embodiment of the shield cap;

FIG. 21 is a section taken generally along line E-E of FIG. 20;

FIG. 22 is a perspective view of the embodiment of the shield cap;

FIG. 23 is a perspective view showing the condition of mounting a shield case on the insulative housing (it should be noted that a cable is eliminated);

FIG. 24 is an explanatory illustration of assembly of the embodiment of the electrical connector, showing the condition of fitting the shield body on the housing body to which the cable is connected;

FIG. 25 is an explanatory illustration of assembly of the embodiment of the electrical connector, showing the condition of bending the cable on the side of a cable clamp of the shield body;

FIG. 26 is an explanatory illustration of assembly of the embodiment of the electrical connect ing the condition of mounting the shield cap on the shield body;

FIG. 27 is a perspective view showing the condition of mounting the shield cap on the subassembly of the insulative housing and the shield case (it should be noted that the cable is eliminated);

FIG. 28 is an explanatory illustration of assembly of the embodiment of the electrical connector, showing the condition of clamping the cable along with a cable holder by the cable clamp of the shield body; and

FIG. 29 is a section taken generally along line F-F of FIG. 28.

### DESCRIPTION OF THE PREFERRED EMBODIMENT

The present invention will be discussed hereinafter in detail in terms of the preferred embodiment of the present invention with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to avoid unnecessarily obscure the present invention.

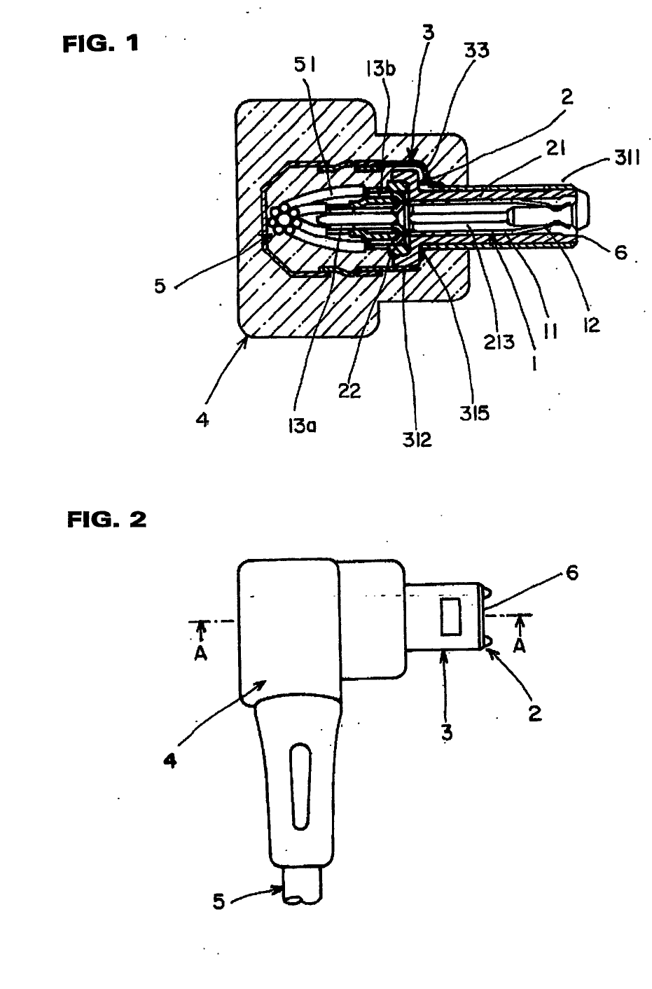

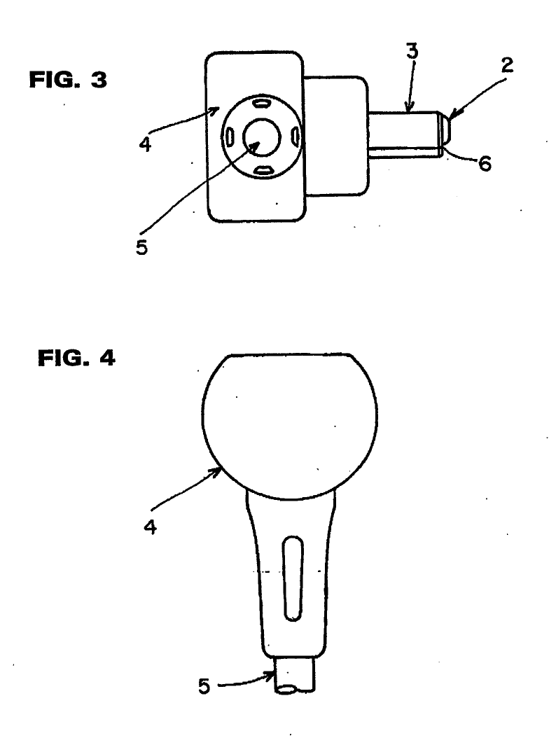

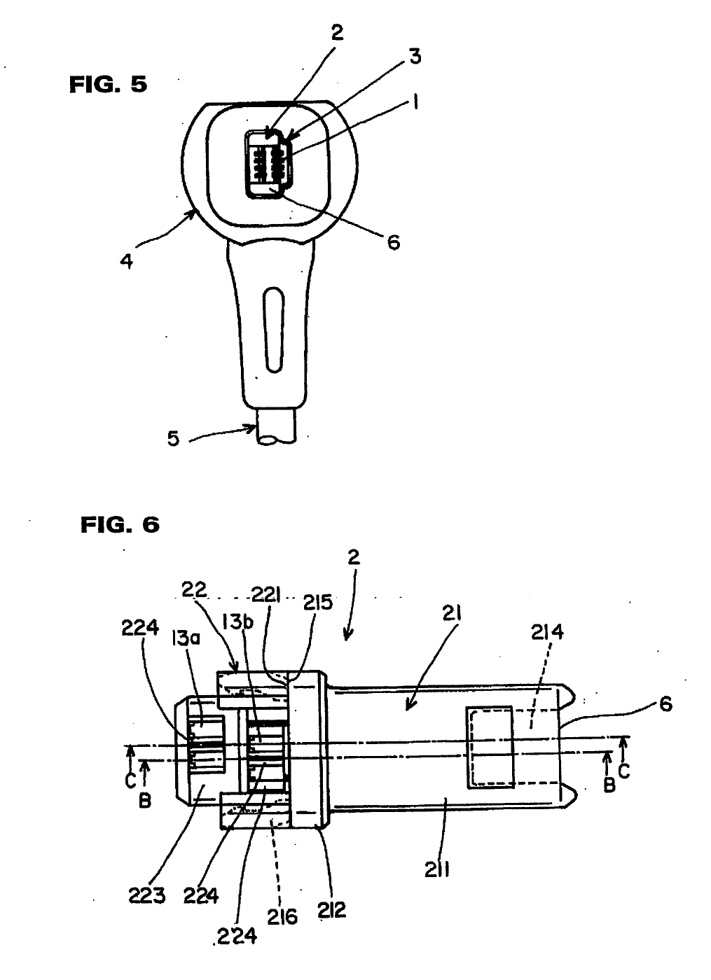

FIG. 1 is a section of an electrical connector shaped as shown in FIGS. 2 to 5, and taken generally along line A-A of FIG. 2. The electrical connector comprises a plurality of terminals 1, an insulative housing 2 for supporting the terminals 1, a shield case 3 for covering the insulative housing 2, and an over-mold portion 4 for shaping the electrical connector. The over-mold portion 4 is formed to cover the shield case 3 in the condition of securing a cable 5 connected to the terminals 1 within the shield case 3. The electrical connector is formed into a L-shape configuration in which the direction of extension of the cable 5 is intersected with the direction of extension of a mating end 6 of the insulative housing 2 surrounded by the shield case 3 at approximately right angle.

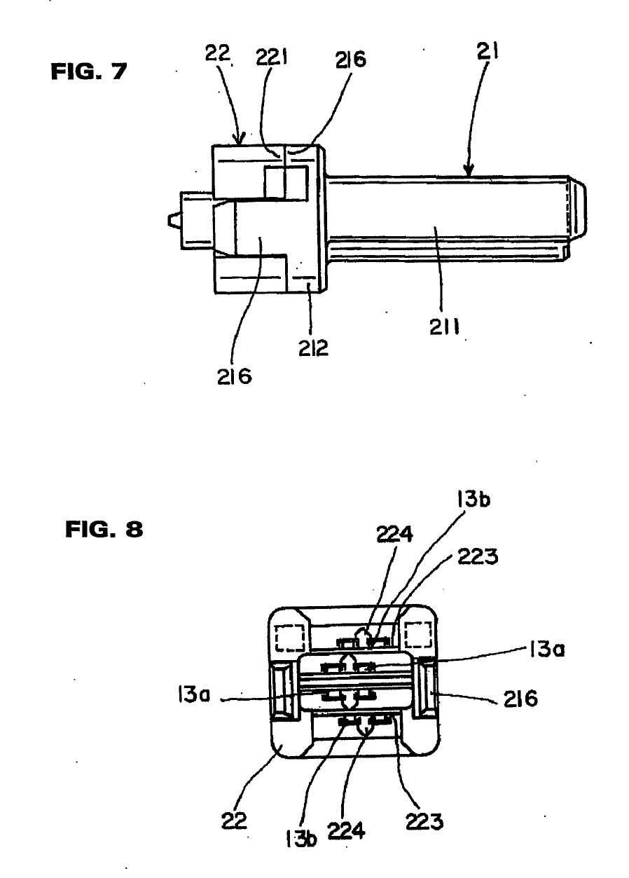

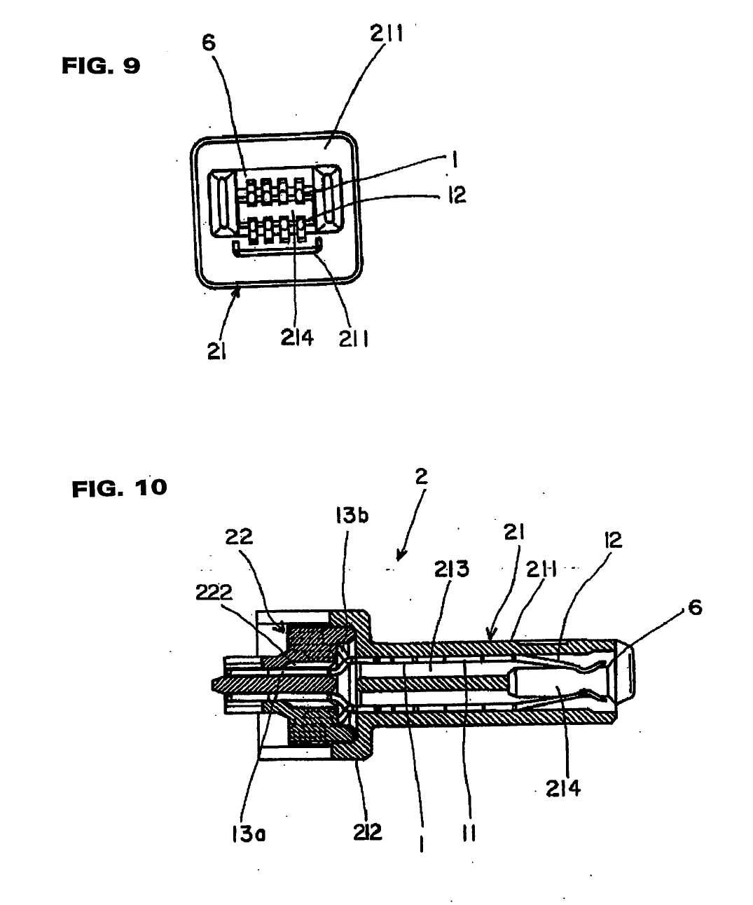

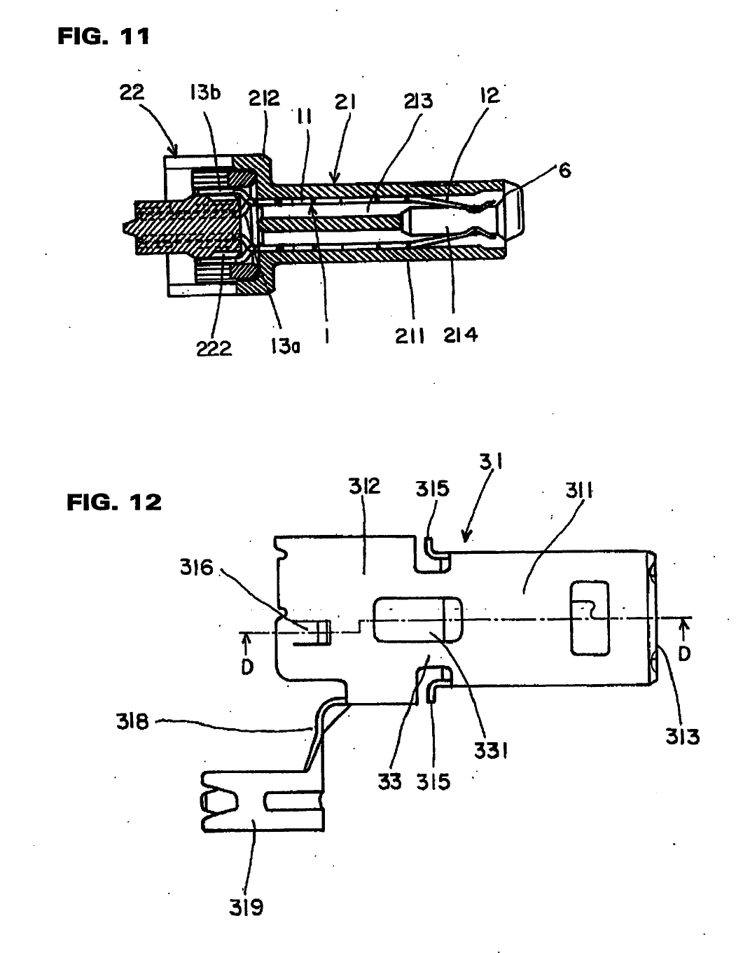

The insulative housing 3 for supporting the terminals 1 includes two components of a housing body 21 and a housing cap 22 as shown in FIGS. 6-11, especially as shown in FIGS. 10 and 11. The two components are respectively formed of insulative plastic. The housing body 21 as one component includes a quadrangular tube-like portion 211 extending rearwardly (at the left hand in FIG. 6) from the mating end 6, and a mating flange portion 212 at the rear end of the quadrangular tube-like portion 211. The quadrangular tube-like portion 211 is provided with terminal receiving spaces 213 transversely aligned in a plurality of columns and vertically aligned in a plurality of rows (arranged in 4×2 matrix in the drawings), and communicated with a receptacle receiving space 214 provided on the inside of the mating end side. Each terminal 1 includes a mounting piece 11 for being inserted into engagement with the terminal receiving space 213, and a contact piece 12 extending in cantilever fashion at the front end of the mounting piece 11, so that the contact piece 12 is opposed to the receptacle receiving space 214 upon inserting the mounting piece 11 into the terminal receiving space 213 from the rear end side of the insulative housing. Terminal pieces 13a, 13b are continuous to the rear end of the mounting piece 11 of each terminal 1 and extended rearwardly (at the left hand in FIG. 6) from the rear end of the quadrangular tube-like portion 211.

Two kinds of the terminal pieces 13a, 13b extending to the rear end side of the mounting piece 11 of each terminal 1 have mutually different length, and the length of the terminal piece 13a is longer than that of the terminal piece 13b. Each of terminal pieces 13a, 13b respectively having a different length is offset on one side (inwardly) or the other side (outwardly) of the mounting piece 11, so that the terminal pieces 13a, 13b are arranged in staggered fashion in each row as viewed from the rear end side (FIG. 8).

The housing cap 22 as the other component for constructing the insulative housing 2 is formed into a block-like configuration including an abutting surface 221 for abutting against a rear end surface 215 of the mating flange portion 212 of the housing body 21, and has terminal insertion holes 222 arranged stagger fashion corresponding to the terminal pieces 13a, 13b arranged in staggered fashion. Each terminal insertion hole 222 is sized to be adapted for inserting one of the terminal pieces 13a, 13b with no space. When the abutting surface 221 is abutted against the rear end surface 215 of the mating flange portion 212 so as to insert the terminal pieces 13a, 13b into the terminal receiving holes 22, an end portion of each of the terminal pieces 13a, 13b is exposed on a supporting surface 223 as shown in FIG. 8 to be connected (soldered) to each electric wire 51 of the cable 5. The supporting surface 223 is provided with separation projections 224 for isolating each of the terminal pieces 13a, 13b to prevent short of the terminal pieces 13a, 13b and prevent connecting material such as solder from flowing out.

The housing body 21 and the housing cap 22 are mated by engaging a latch piece 216 projecting rearwardly from both sides of the mating flange portion 212 of the housing body 21 with both side walls of the housing cap 22, so that rear end opening portions of the terminal receiving spaces 213 formed in the housing body 21, i.e., insertion slots of the terminals 1 are sealed by the housing cap 22.

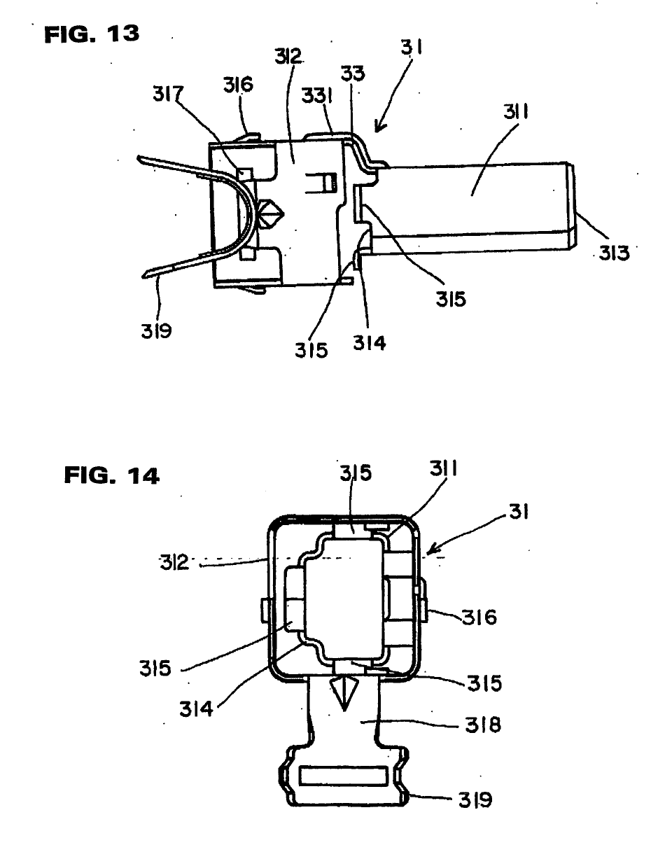

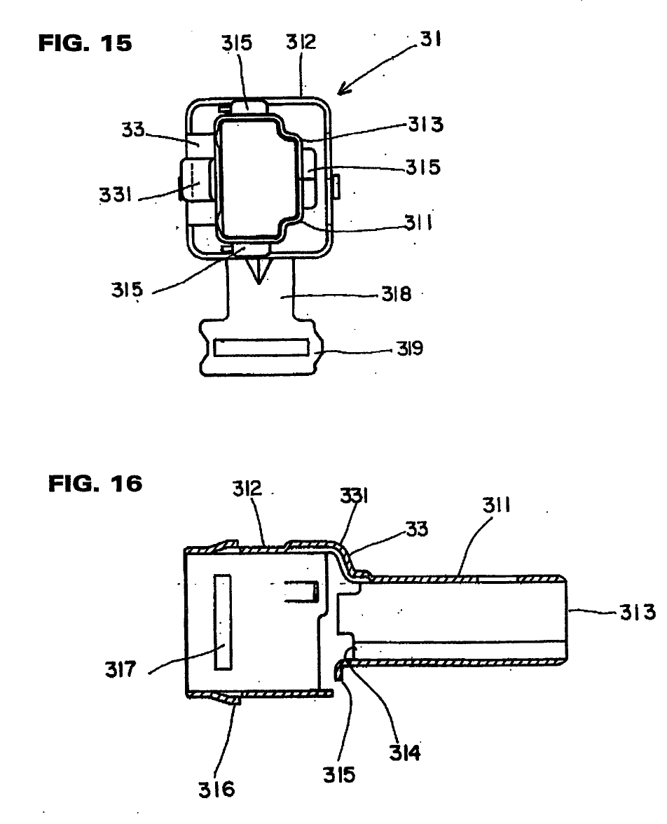

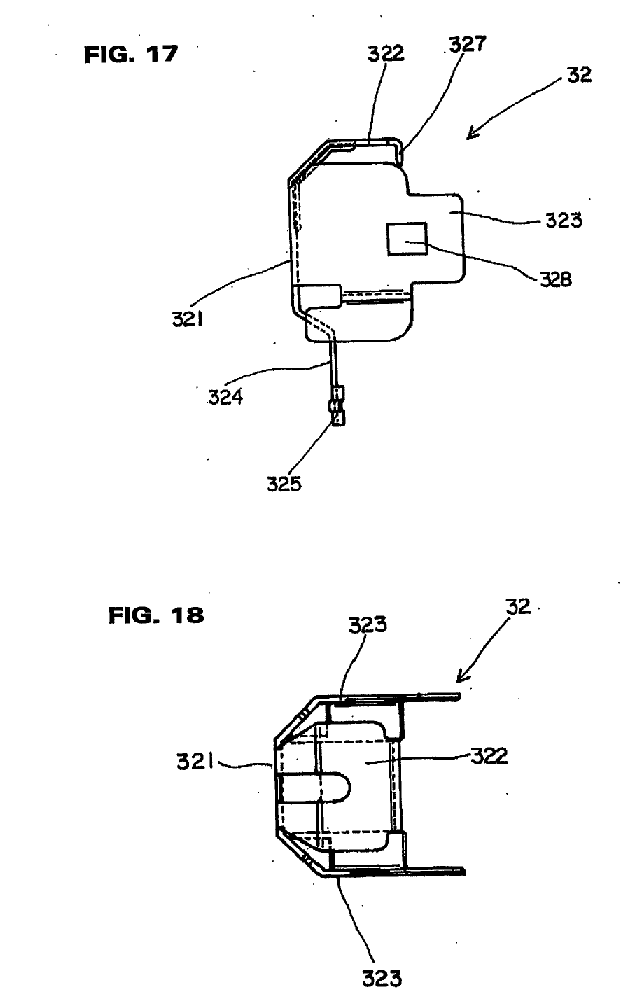

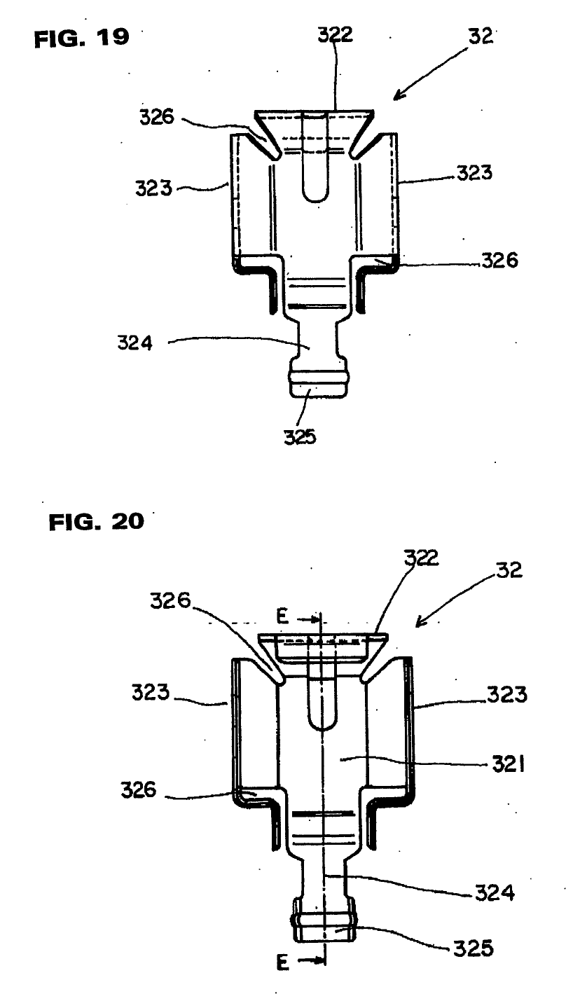

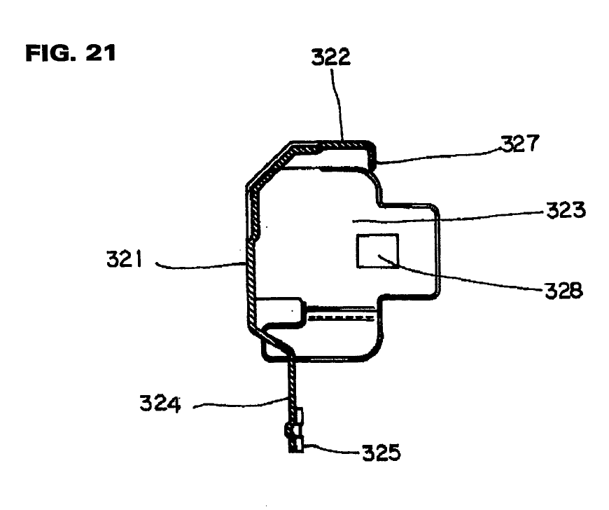

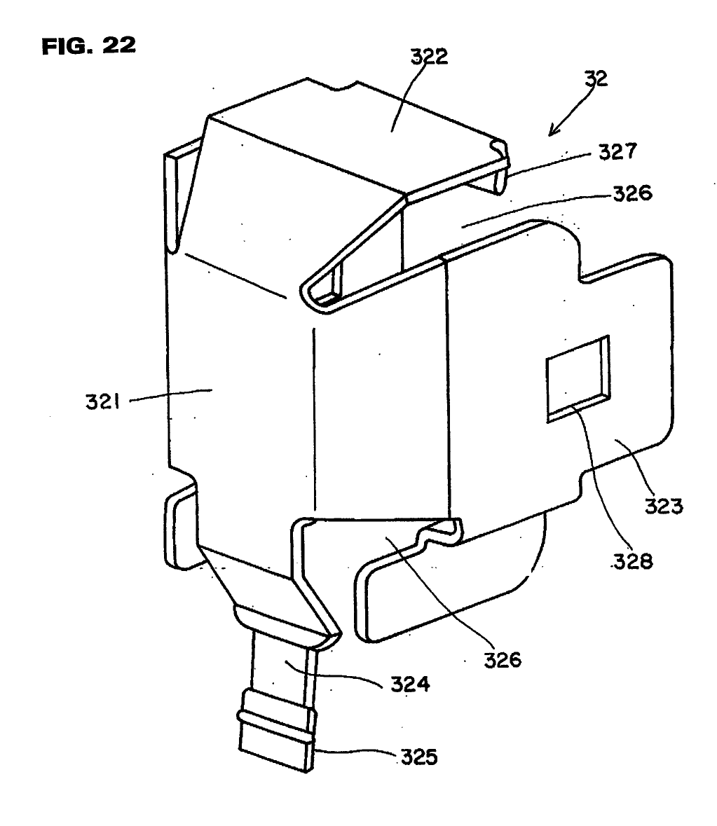

Next, the shield case 3 includes a shield body 31 shown in FIGS. 12 to 16, and a shield cap 32 shown in FIGS. 17 to 21. The shield case 3 and the shield cap 32 are respectively stamped from a metal sheet and formed as shown in the drawings. The shield body 31 has a quadrangular tube-like portion 311 for fitting with an outer surface of the quadrangular tube-like portion 212 of the housing body 21 with no space therebetween, and a box-like portion 312 for accommodating the mating flange portion 212 of the housing body 21 and the housing cap 22. The quadrangular tube-like portion 311 is integrated with the box-like portion 312 by integrally connecting mutually opposing side walls thereof via a continuous piece 33. The continuous piece 33 is bended to make the center of the quadrangular tube-like portion 311 substantially consistent with that of the box-like portion 312 as shown in FIG. 13. In the center of the continuous piece 33, a reinforcing rib 331 is provided along a longitudinal direction of the shield case to reinforce the integrity of the quadrangular tube-like portion 311 and the box-like portion 312.

The quadrangular tube-like portion 311 has a substantially identical length with the length of the quadrangular tube-like portion 211 of the housing body 21 to make a front edge 313 consistent with the mating end 6. On the other hand, a rear edge 314 is oppositely mated with the front surface of the mating flange portion 212 of the housing body 21. Also, the rear edge 314 is provided with three walls except for the wall having the continuous piece 33. Namely, a bending piece 315 is projected substantially perpendicularly from one side wall, an upper wall and a bottom wall of the rear edge 314, respectively.

The box-like portion 312 has a sufficient capacity for accommodating the mating flange portion 212 of the housing body 21 and the housing cap 22 to make space into which the resin for forming the over-mold portion 4 can flow. On both side walls of the box-like portion 312, engaging pieces 316 are outwardly projected for engaging with the shield cap 32. In the upper wall of the box-like portion 312, an elongated window 317 is formed for engaging with the shield cap 32. Further, a strip tab 318 is extended from the bottom wall of the box-like portion 312 in a reversed L-shape fashion, and is provided with an arc-shaped cable clamp 319 at the tip end thereof.

The shield cap 32 includes a curved upper connecting piece 322 extending forwardly from the upper edge of a quadrangular plate 321 having smaller size than a quadrangular opening portion of a rear end opening portion of the box-like portion 312 of the shield body 31, and curved lateral connecting pieces 323 extending forwardly from both side edges of the quadrangular plate 321. The upper connecting piece 312 is overlapped into engagement with the upper side of the box-like portion 312, and the lateral connecting pieces 323 are overlapped into engagement with the outside of the box-like portion 312. Also, a curved depending piece 324 is extended from the lower edge of the quadrangular plate 321 for opposing to the strip tab 318 provided on the box-like portion 312 in substantially parallel. The lower end of the depending piece 324 is formed as an arc-shaped wider portion in cross-section to provide a cable holder 325. A space 326 is respectively made between the upper connecting piece 322 and the lateral connecting pieces 323, between the depending piece 324 and the lateral connecting pieces 323 so that the resin for forming the over-mold portion 4 can flow into the shield case 3.

At the tip end of the upper connecting piece 322, an engaging piece 327 depending substantially perpendicularly is provided for engaging with the elongated window 317 of the box-like portion 312. Quadrangular windows 328 corresponding to the engaging pieces 316 of the box-like portion 312 are also provided on the lateral connecting pieces 323. Firstly, the engaging piece 327 is engaged with the window 317, and then the whole shield cap 32 is pivoted about the engaging portion as a base point to remove the lateral connecting pieces 323 forwardly along the side walls of the box-like portion 312, so that the quadrangular windows 328 are moved into engagement with the position of the engaging pieces 316 to mate the shield cap 32 with the shield body 31.

The electrical connector shown in FIG. 1 and FIGS. 2 to 5 is assembled as follows by the respective members as set forth above. Namely, for preparing subassembly, the terminals 1 are firstly mounted into the terminal receiving spaces 213 of the housing body 21 of the insulative housing 2 from the rear end side thereof so that the terminal pieces 13a, 13b are projected from the rear end of the housing body 21. The housing cap 22 is mounted on the subassembly. The housing cap 22 is mounted so that the rearwardly projecting terminal pieces 13a, 13b pass through the terminal insertion holes 222 formed in the housing cap 22. By mounting the housing cap 22 as set forth above, the opening portion on the rear end side of the terminal receiving spaces 213 formed in the housing body 21 is sealed by the housing cap 22.

Next, the electric wires 51 of the cable 5 are connected to the terminal pieces 13a, 13b exposed on the supporting surface 223 formed in the housing cap 22 by means of solder or the like. As set forth above, the terminal pieces 13a, 13b are respectively isolated by the separation projections 224 to prevent short thereof, and prevent molten solder from flowing around the adjacent terminal pieces 13a, 13b, so that it is possible to appropriately connect the terminal pieces 13a, 13b corresponding to the electric wires 51.

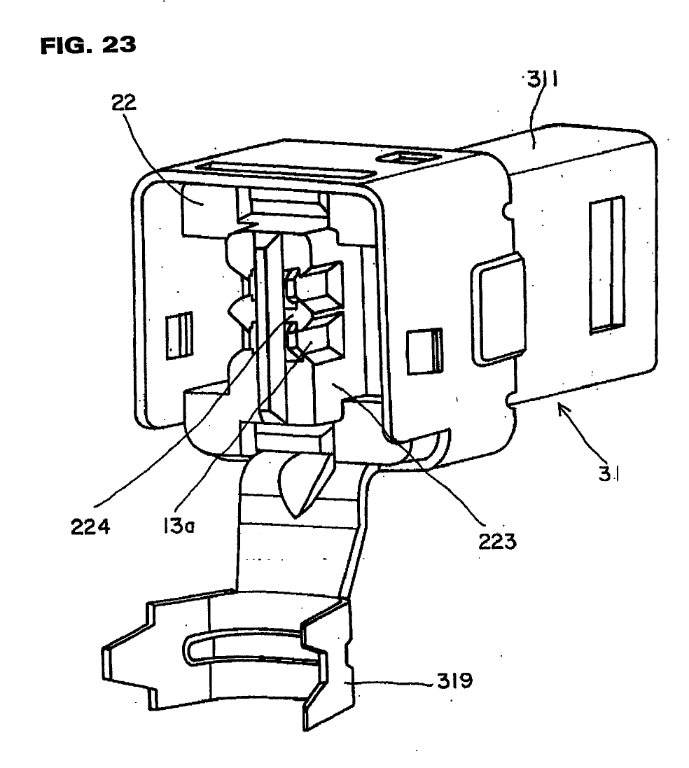

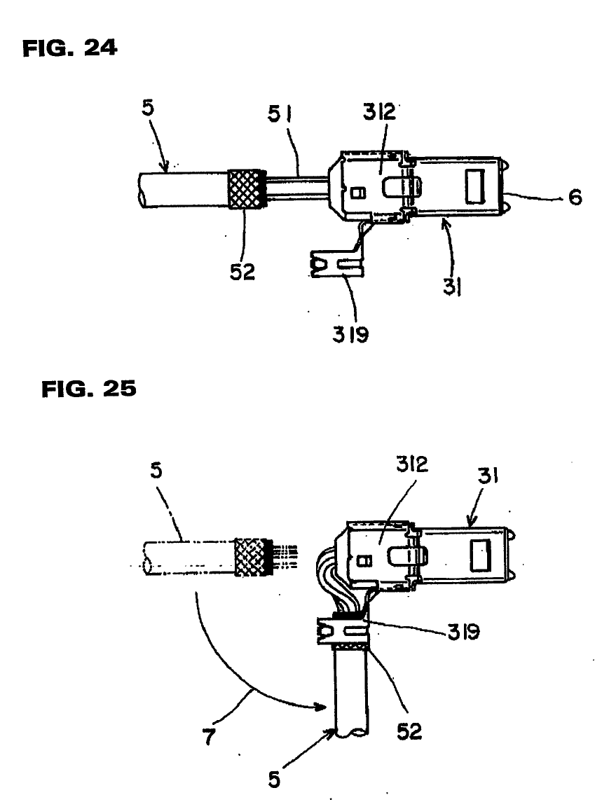

The shield body 31 of the shield case 3 is then fitted to the insulative housing 2 to which the electric wires 51 are connected set forth above, from the side of the mating end 6 of the housing body 21. Such a condition is shown in FIGS. 23 and 24 (it should be noted that the cable 5 is eliminated in FIG. 23). Next, the rearwardly extending cable 5 is bended as indicated by an arrow 7 of FIG. 25, and a shield net 52 exposed at the terminal portion of the cable 5 is accommodated within the cable clamp 319 provided on the bottom of the box-like portion 312 of the shield body 31. Upon bending the cable 5, the external force is applied to the terminal pieces 13a, 13b connected to the electric wires 51. However, the terminal pieces 13a, 13b are supported on the supporting surface 223 of the housing cap 22, and respectively isolated by the separation projections 224, so that it is possible to prevent damages of the connecting portions such as peeling of solder, and mutual short of the terminal pieces 13a, 13b.

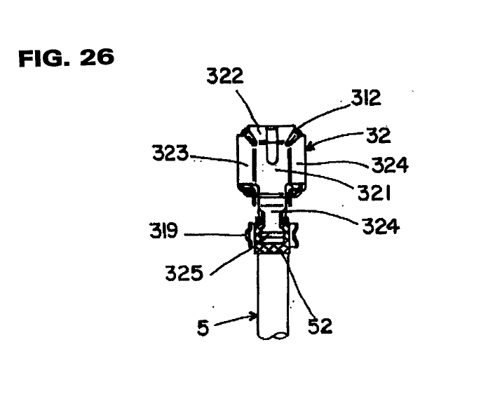

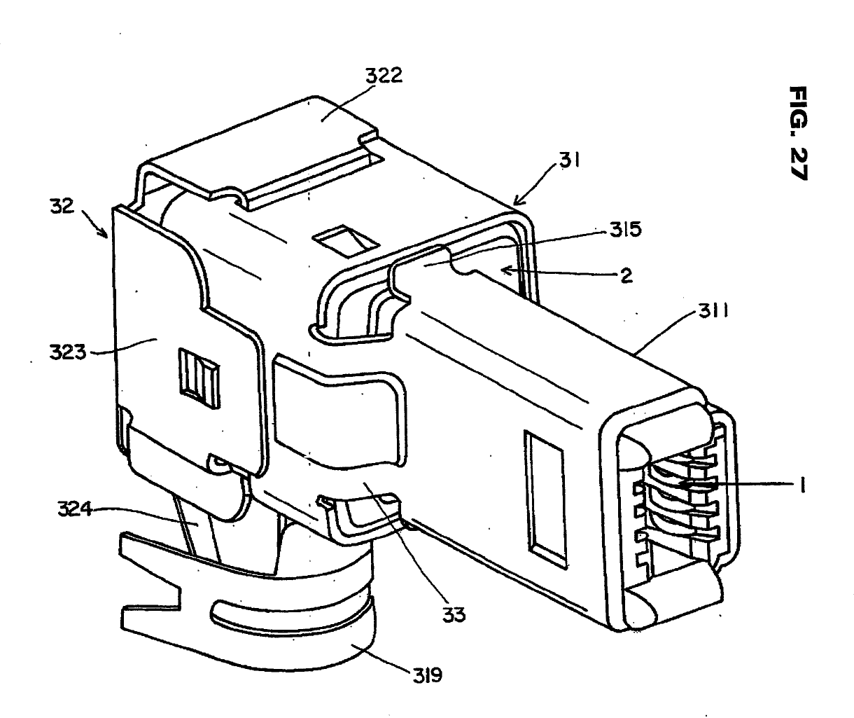

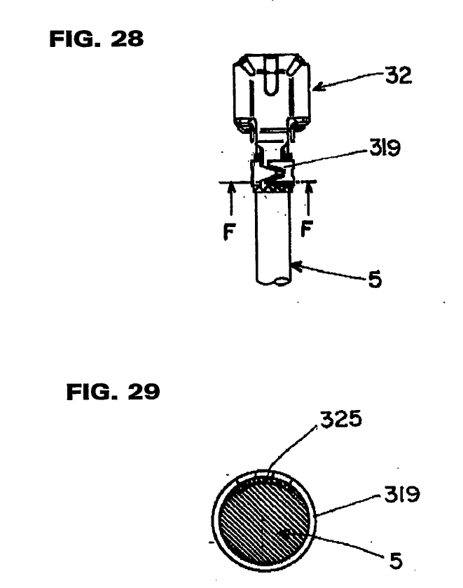

Next, the shield cap 32 is mounted to the box-like portion 312 of the shield body 31 to seal the opening portion at the rear end of the box-like portion 312 by the shield cap 32 as shown in FIGS. 26, 27. The opening portion at the rear end of the box-like portion 312 are substantially sealed by four surfaces of the quadrangular plate 321, the upper connecting piece 322, and two lateral connecting pieces 323. The manner of mounting the shield cap 32 to the box-like portion 312 is set forth above. When the shield cap 32 is mounted, the depending piece 324 depending from the lower edge of the quadrangular plate 321 of the shield cap 32 lies along bended electrical wires 51, and the cable holder 325 is overlapped on the shield net 52. Then, the cable 5 is clamped along with the cable holder 325 by claiming the cable clamp 319 around the cable 5 as shown in FIG. 28. FIG. 29 is a cross-section of clamping portion thereof.

As set forth above, the over-mold portion 4 is formed by accommodating the assembly of the terminals 1, the insulative housing 2, the shield 3, and the cable 5 into a given mold and over-molding the insulative resin to complete the electrical connector shaped as shown in FIGS. 2-5. The resin for forming the over-mold portion 4 flows into the inside of the shield case 3 through the spaces 326 formed in the shield cap 32, as shown in FIG. 1. The housing cap 22 prevents the resin flowing into the inside from flowing into the terminal receiving spaces 213 on the side of the housing body 21. Accordingly, it is possible to prevent the over-molding resin from contaminating the contact pieces 12 of the terminals 1, and to reduce the possibility of causing contact failure of the contact pieces 12. The resin flowing into the shield case 3 flows to the continuous piece 33 connecting the quadrangular tube-like portion 311 and the box-like portion 312 of the shield body 31 to secure the cable 5 and the electric wires 51 accommodated within the shield body. Further, the resin forming the over-mold portion 4 outside of the shield case 3 embraces the region where the cable 5 and the cable holder 325 are clamped by the cable clamp 319, and embraces to the extent of the intermediate portion of the quadrangular tube-like portion 311 of the shield body 31 of the shield case 3. The resin embracing to the extent of the quadrangular tube-like portion 311 embraces outside of the continuous piece 33 continuous to the quadrangular tube-like portion 311 to place the continuous piece 33 in a buried condition, in cooperation with the resin flowing into inside of the continuous piece 33. Further, three bending pieces 315 projecting from the rear edge 314 of the quadrangular tube-like portion 311 are also placed into the buried condition, so that the bending pieces 315 are secured by the resin of the over-mold portion 4.

Although the present invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodied within a scope encompassed and equivalents thereof with respect to the feature set out in the appended claims.

1. An electrical connector comprising:
a shield case for covering an insulative housing mounting a plurality of terminals, each of the terminals having a contact piece and a terminal piece, at least a portion of the terminal piece extending from the insulative housing in a direction away from the contact piece, the terminal piece being capable of being connected to an electric wire of a cable;
an over-molding portion for securing the shield case along with the cable to shape the electrical connector;
the shield casing having a tube-like portion engaging with a portion of the insulative housing and a box-like portion internally receiving at least a portion of the terminal piece and the electrical wire of the cable;
the tube-like portion and the box-like portion being connected via a continuous piece, the tube-like portion including a bending piece externally projecting from an edge of the tube like portion, the continuous piece and the bending piece being embedded in the over-molding portion.

2. An electrical connector as set forth in claim 1, wherein the tube-like portion is a quadrangular tube-like portion, wherein one wall being continuous with the box-like portion via the continuous piece, and three walls being provided projecting the bending piece.

3. An electrical connector as set forth in claim 1 or 2, wherein the continuous piece is bended to make the center of the quadrangular tube-like portion substantially consistent with that of the box-like portion.

4. An electrical connector as set forth in claim 1 or 2, wherein the electrical connector is formed into a L-shape configuration in which the direction of extension of the cable is intersected with the direction of extension of a mating end of the insulative housing surrounded by the shield case at approximately right angle.

5. An electrical connector as set forth in claim 1, comprising:
a shield cap mounted on the shield body,
a strip tab extending from the box-like portion, an end portion of the strip tab being provided with a cable clamp, a depending piece extending from the shield cap, and a cable holder being provided at the end portion of the depending piece, and
the cable clamp commonly clamping the cable and the cable holder.

6. An electrical connector as set forth in claim 5, wherein the shield cap is formed with a quadrangular plate smaller than an opening portion of an end portion of the box-like portion, bent continuous pieces extending from an upper edge and a side edge of the quadrangular plate, and the depending piece depending from a lower edge of the quadrangular piece, and a gap being formed between the upper connecting piece and the lateral connecting pieces, and between the depending piece and the lateral connecting pieces.

7. An electrical connector as set forth in claim 6, wherein the quadrangular plate of the shield cap, the continuous pieces and the depending piece closes the end opening portion formed in the box-like portion of the shield body.

8. An electrical connector as set forth in any one of claims 5 to 7, wherein the tube-like portion and the box-like portion are continuous via the continuous piece, a bending piece extends externally from the end edge of the tube-like portion, the continuous piece and the bending piece are embedded in the over-molding portion, and resins of the bending portion and the over-molding portion are engaged.

9. An electrical connector as set forth in claim 8, wherein the tube-like portion is a quadrangular tube-like portion, wherein one wall being continuous with the box-like portion via the continuous piece, and three walls being provided projecting the bending piece.

10. An electrical connector as set forth in claim 8, wherein the continuous piece is bended to make the center of the quadrangular tube-like portion substantially consistent with that of the box-like portion.

11. An electrical connector as set forth in claim 8, wherein the electrical connector is formed into a L-shape configuration in which the direction of extension of the cable is intersected with the direction of extension of a mating end of the insulative housing surrounded by the shield case at approximately right angle.

12. An electrical connector as set forth in claim 1, wherein the insulative housing includes a housing body formed with terminal receiving spaces, and a housing cap formed with terminal insertion holes;
rear end opening portions of the terminal receiving spaces formed in the housing body being sealed by the housing cap; and
terminal pieces of the terminals mounted in the terminal receiving spaces rearwardly extending through the terminal insertion holes of the housing cap.

13. An electrical connector as set forth in claim 12, wherein the housing body includes a rear end surface having openings for the terminal receiving spaces, and the housing cap includes an abutting surface for abutting against the rear end surface, so that the rear end opening portions of the terminal receiving spaces are sealed by abutting the abutting surface against the rear end surface.

14. An electrical connector as set forth in claim 12, wherein the housing cap includes a supporting surface for supporting terminal pieces rearwardly exposing through the terminal insertion holes.

15. An electrical connector as set forth in claim 14, wherein the supporting surface includes separation projections for isolating adjacent terminal pieces.
